(19) United States
(12) Patent Application Publication
(10) Pub. No.: US 2001/0032133 A1
(43) Pub. Date: Oct. 18, 2001

(54) System for message delivery in interactive communication networks

(76) Inventor: Dan Moran, Pasadena, CA (US)

Correspondence Address: OPPENHEIMER WOLFF & DONNELLY, LLP, P.O. BOX 52037, Palo Alto, CA, 94303-0746, US

(21) Appl. No.: 09/792,854

(22) Filed: Feb. 23, 2001

Related U.S. Application Data
(63) Continuation-in-part of application No. 09/585,601, filed on Jun. 2, 2000.
(60) Provisional application No. 60/178,679, filed on Jan. 28, 2000.

(51) Int. Cl. G06F 17/60

(52) U.S. Cl. 705/14

(57) ABSTRACT

A message delivery system (10) for delivering messages (20) embedded in content (22) which is made accessible to an audience member (12) on an interactive communications network. A message provider (14) provides the messages (20) and once they are embedded into the content (22) a content provider (16) makes them available on the network. The message provider (14) and the content provider (16) may be distinct entities or the same. The content is selected from a database based on a pre-determined customizable criterion relating to the individual user. The content (22) may be audible or visual, particularly including text, or may be combinations of such. In turn, the messages (20) may take any of these forms. The audience (12) is motivated to seek out, obtain, and use the content (20), and thereby concurrently perceive the messages (20), because the content (20) has an intrinsic or extrinsic desirability to the audience (12). In particular, the messages (20) may be for advertising or educational purposes.

### CROSS-REFERENCE TO RELATED APPLICATIONS

This application is a continuation-in-part of U.S. patent Application Ser. No. 09/585,601, filed Jun. 2, 2000, which claims the benefit of U.S. Provisional Application No. 60/178,679, filed Jan. 28, 2000.

### TECHNICAL FIELD

The present invention relates generally to interactive communication networks, and more particularly to systems to communicate messages to audiences in such networks. It is anticipated that a primary application of the present invention will be in online advertising and other commercial endeavors. However, the present invention is also well suited to use in education, particularly in the home and in public awareness contexts.

### BACKGROUND ART

The most significant challenges in communicating with an Internet audience are the ability to gather the audience to hear the message and the ability to create messages that do not irritate the audience. In the past these obstacles have been difficult to overcome because companies have been trying to adapt message delivery paradigms from other media (including print and broadcast) to the Internet. The result has been message systems such as banner ads, pop-up windows, ad bars, and unsolicited e-mails, with which it has become increasingly difficult to effectively communicate without serious drawbacks which repel rather than attract the audiences. In studying the problems of existing Internet message delivery systems the inventor has observed that effective message delivery systems should preferably be: fast, free, user-directed, intuitive, useful or interesting, community building, and not bothersome or irritating.

Internet users form a vast group intrigued by novelty and highly responsive to change. They will actively seek out message delivery systems, and the sites and companies that provide them, when such systems satisfy their constant demand for more interactive and eimmersive content. Thus, companies (and other organizations and individuals) using such web-sites can benefit simply from the ability to identify and gather an audience. Today many such companies are not concerned with the specific message that is being delivered to the audience, but rather the value of the presence of, and the access to, the audience for their own purposes. Such companies therefore seek: highly differentiated site content; site-specific demographic information; targeted user-groups; and returning, “sticky” users.

The old paradigm under which most established Internet message delivery systems currently operate results in unwieldy adaptations of systems used in traditional print and television media. In the case of advertising, essentially passive visual imagery is inserted into the content of the websites on which the ads reside. As such, they tend to irritate Web users by cluttering their Web experience with content that consumes space and distracts them from what they are actually looking for. These irritating techniques have taught users to filter what they view. Most users no longer even notice such advertisements, and those that do actively try to avoid them.

Some of the specific attempts at delivering advertising messages presently utilized on the Web include: banner ads and ad bars; pop-up windows (interstitials); subject lists; and “spam” and permission advertising.

Banner ads are typically long thin graphics that run across a website. Their goal is to convince users to click on the banner, taking them to the advertiser's own website. They rely on being placed on a website that is sufficiently interesting to attract Web users, just as TV commercials are matched with popular programs. However, unlike TV commercials, these Web ads cannot monopolize users' attention. Such Web-ads can only share space with a site's own content, so advertisers must hope that their ads are more engaging than the content which the users have come to see. This is untenable; the content is intrinsically more interesting than the ad. The more interesting the site, the less likely it is that a banner ad will be effective. Thus, this technique competes with itself. Today, “. . . people view Web banners as background noise” (eAdvertising Report, eMarketer, New York, N.Y., Vol. 1., April, 1999).

Moreover, some advertisers try to disguise their ads as integrated content of the site that they reside upon. The result is that many Web users find themselves deceived into clicking on these ads and being sent to sites that they had no interest in visiting. In these cases, banner ads can actually be counter-effective despite their apparent success in simply directing users to the advertiser's targeted website. Users duped into visiting another website in this manner have no incentive to stay and learn about the new site, and actively avoid doing so. For this reason and others, click-through rates on banner ads have fallen to less than 1%. Conservative estimates state that 35% of Web users never even click on banners (eAdvertising Report).

Some new attempts at increasing the effectiveness of banner ads are known as ad bars. These methods consist simply of offering Web users some incentive (usually financial) to allow a special advertising bar to run at all times during the user's Web experience. Companies such as NetZero and AllAdvanatge are presently experimenting with this technique. Although these arrangements succeed in making the presence of the banners less objectionable to the audience, they are just as (if not more) easy for users to ignore and have not demonstrated any quantifiable success in increasing the effectiveness of banner advertising. Ad bars do not circumvent ad avoidance behavior. In 1998, Market Facts Telenation found that 80% of Web users would not agree to view ads in exchange for prizes or discounts.

Pop-up windows have a superficial logic which initially might seem sound. If the obstacle that banner ads face is the difficulty of convincing the audience to click-on a banner in order to direct them to a new website, it would seem that simply having the desired site appear in a separate window would overcome this obstacle. However, Web users have consistently demonstrated that pop-up windows are not only ineffective, but counter-productive. “Many net users find [these ads to be] intrusive, a bother, irritating, or distracting” (eAdvertising Report). In fact, not only are users likely to simply close the popped-up window, they are also likely to close the window that created the pop-up and avoid sites where they know pop-ups will occur.

Subject lists are another popular method in current use, one which is derived from the concept of the Yellow Pages. Advertisers pay to have clients listed on a table of links alongside other companies similar to the client, usually accessed using one of the major Internet search engines, such as Yahoo! (™), Excite (™), Go (™), Lycos (™), etc. For example, a roofing company would be advertised with other roofing companies on a roofing subject list. Theoretically, this is supposed to draw users to clients' websites, but once again, this method fails to take advantage of current Web technology. These links are non-interactive; there is nothing a user can do with a link but look at it. Furthermore, users may indeed find a link to a client by this method, but at the same time they will be presented with the client's competitors, with nothing to differentiate one company from another. Perhaps most importantly, subject lists can only motivate a user to learn about a client if that user is already actively looking for a specific service and knows what he or she wants. Subject lists cannot present general corporate messages, create company and product awareness, or offer any of the many other components of an advertising campaign that motivate their audiences to act. These subject lists are typically found at search engines at the major portal sites and are generally considered an unsatisfactory way to advertise, receiving low scores based on comparisons between the advertising dollars spent and the actual number of pageviews they deliver.

Spam and permission advertising are perhaps the most desperate methods to disseminate advertising messages on the Internet. These attempt communication in the form of unsolicited emails, referred to un-affectionately by Web users as “Spam.” Based on a traditional direct-marketing model, Spam is unsolicited email sent directly to a user's email address. Because the characteristics that have made this method effective for traditional mailings (i.e. graphics, coupons, fancy stationary, and other gimmicks) are not available, Internet users are becoming increasingly adept at identifying and deleting Spam without reading its content. This phenomenon is compounded by the proliferation of email programs that automatically identify and delete Spam email before the user even sees it. Spam's proliferation has created a significant stigma against companies that use it as an advertising method due to its negative externalities, and most Net users are fearful of “being Spammed.”

A second, and only slightly more effective, version of this method is known as Permission Advertising. This method attempts to get users to “sign-on” or give permission to companies to send them email on a certain subject. This technique, when used scrupulously, can be effective at maintaining correspondence between a user and a site that they have already established some relationship with. As an advertising technique, however, it is problematic. Usually, the company that received the user's permission will resell its list of users to advertisers who are targeting audiences interested in a specific subject. Thus, the original site abdicates most of the responsibility for what the user receives and the same end-result arises: users are bombarded with email that they did not want. Furthermore, users are often able to identify which list was sold, causing them to have a severe negative reaction to the company with which they signed on. This destroys the very relationship that the advertiser was trying to create. Again, ad avoidance behavior occurs.

All of these examples are “push” technology, ones in which the information provider determines what the user sees, e.g., as in the cases of radio and television. In contrast, “pull” technology allows the user to select what information he or she receives. The World Wide Web is based on pull technology, and this is one particular reason why these push-based examples fail.

What is needed today are messaging systems which follow a new paradigm, Internet-based message delivery systems which circumvent the drawbacks associated with traditional systems and which simultaneously create value for companies wishing to effectively deliver a message and for websites wishing to attract and keep a sizeable audience.

### DISCLOSURE OF INVENTION

Accordingly, it is an object of the present invention to provide an Internet-based message delivery system for advertising, educating, raising public awareness, and corresponding with audiences in a unique, targeted, and inoffensive manner.

Another object of the invention is to provide an Internet-based message delivery system which not only ensures that information is conveyed successfully to audiences, but also one that creates and identifies the audiences.

And another object of the invention to provide an Internet-based message delivery system which may include highly differentiated site content; site-specific demographic information; targeted user-groups; and returning, sticky users.

Another object of the present invention is to provide a message delivery system that can deliver message to an individual user member on a targeted basis.

In one embodiment of the present invention, a system is provided to deliver a message on an interactive communication network to an individual user on a targeted basis. In particular, a message is provided which is intended for an individual user. A content is selected from a database based on a pre-determined customizable criterion relating to the individual user. The message is embedded into the content such that the message becomes an embedded message. The user then perceives the embedded message whenever perceiving the content.

An advantage of the present invention is that it communicates inoffensively with its audiences, without the drawbacks (like audience irritation) that currently plague conventional systems such as banner ads, pop-up windows, ad bars, and unsolicited e-mails.

Another advantage of the invention is that, by bringing the audience to the message and also bringing the message to the audience, it delivers messages more effectively than current Internet-based alternatives.

Another advantage of the invention is that it enhances existing Internet presences with intrinsic value to its audiences in the form of sticky content which voluntarily attracts and retains such audiences.

And another advantage of the invention is that it may be fast, free, user-directed, intuitive, useful or interesting, community building, and not bothersome or irritating to its user audiences.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a schematic illustrating generally the process of message delivery according to the present invention;

FIG. 2 is a chart schematically depicting information flow from the message provider to the audience in the embodiment of FIG. 1;

FIG. 3 is a block diagram stylistically depicting the message delivery system applied in the larger context of a competitive environment wherein multiple message providers strive for the attention of the audience;

FIG. 4 is a schematic stylistically depicting how flexibly the message delivery system can be used in different steps of a marketing plan;

FIG. 5 is a chart schematically depicting information flow when the audience seeks the content provided by a content provider;

FIG. 6 is a table summarizing examples of particular content types and variations which may be employed; and

FIG. 7 is a block diagram of how the present message delivery system can extend the traditional marketing model into a more powerful online one.

### BEST MODE FOR CARRYING OUT THE INVENTION

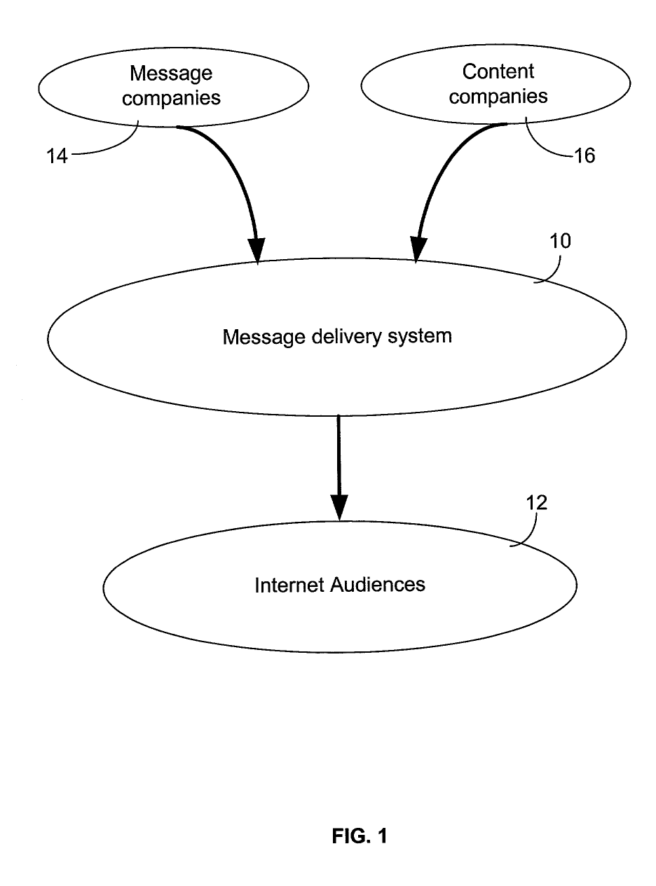

A preferred embodiment of the present invention is an Internet-based message delivery system. As illustrated in the various drawings herein, and particularly in the view of FIG. 1, a form of this preferred embodiment of the inventive device is depicted by the general reference character 10.

FIG. 1 illustrates in schematic form the process of delivering messages on the Internet (and more specifically the World Wide Web) employing a message delivery system 10 according to the present invention. To reach an audience 12, message providers 14 and content providers 16 may use the message delivery system 10 as their medium.

The audience 12 seeks valuable and entertaining Internet content. Within the context of this the message providers 14 want to send messages to the audience 12, but need to do so in a way that will reach the audience 12 and not alienate it from them. The content providers 16 want to provide content which is interesting and attractive to the audience 12, but need to do so in a way that does not lose or repel the audience 12. As is already the case for providers using other systems, the message providers 14 and the content providers 16 will primarily be companies, using the message delivery system 10 for their own purposes or doing so as a service for others. However, it need not necessarily be the case that only companies use the message delivery system 10, and it should be appreciated that other types of organizations and even individuals can employ it as well.

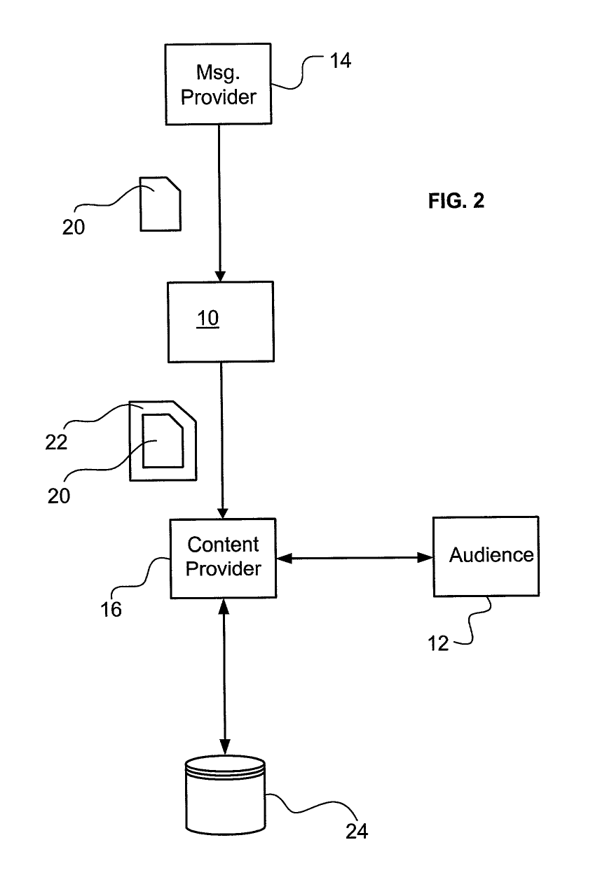

FIG. 2 is a chart of the information flow from a message provider 14 to an audience 12. The message provider 14 is shown topmost to emphasize its role as the origin or starting point in the process of message delivery. The message provider 14 provides a message 20 that it wishes to communicate to the audience 12. This message 20 is passed to the message delivery system 10, where it is embedded into a content 22. The content 22 is then stored by a content provider 16 in some manner, such as in the content database 24 shown. The audience 12 then comes to the content provider 16 and accesses the content 22 in the content database 24, concurrently also receiving the previously embedded message 20.

It should particularly be noted that the process depicted in FIG. 2 is a pull based technique, rather than a push based technique. It brings the audience 12 to the message 20, in contrast to prior art techniques where messages are pushed upon an audience. The key to delivering the message 20 is the content 22. If the content 22 is not attractive enough, the audience 12 will not come, and will never experience the message 20. If the content 22 is not valuable enough the audience 12 will only come a few times, experience such messages 20 only a few times, and not come back. And if the content 22 is easily overwhelmed by the message 20, say, due to abusive elements or over use by message providers 14, the audience 12 may come to actively avoid such content 22. These are all failings of the prior art, in varying degrees and respects, but ones which the message delivery system 10 is particularly able to avoid.

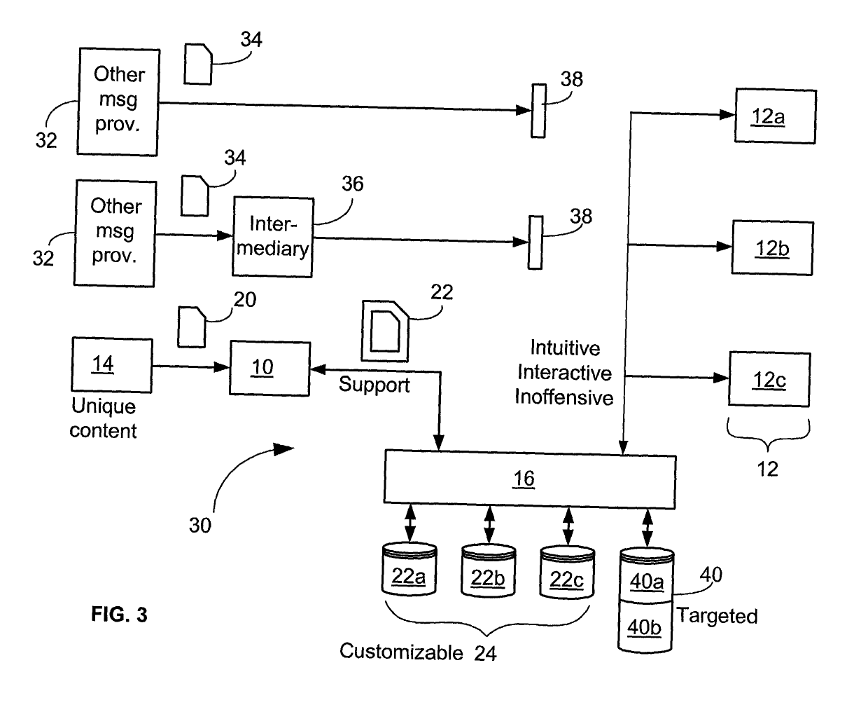

FIG. 3 is a block diagram which stylistically depicts the message delivery system 10 in the larger context of a competitive environment 30, wherein multiple message providers strive for attention from an audience 12. The goal is to get messages to the audience 12. A message provider 14 using the message delivery system 10 seeks to get its message 20 to the audience 12. And other message providers 32 seek to send alternate messages 34 to the audience 12. The messages 20 and the alternate messages 34 may be essentially the same, e.g., “buy our widget” or “vote for our candidate,” and may just be coming from a different source and traveling via different message delivery systems.

The other message providers 32 may employ traditional direct methods, like sending the alternate messages 34 as Spam, or they may employ intermediaries 36, e.g., a portal site where banner ads point to the alternate messages 34.

However, the alternate messages 34 from the other message providers 32 do not reach the audience 12. They encounter barriers 38. As is the case today with the majority of Internet users, the audience 12 avoids irritating and misleading prior art attempts at message delivery, e.g., it filters out Spam and it ignores banners.

FIG. 3 also depicts several attributes of the message delivery system 10. It may be intuitive, due to use of simple, user-friendly interfaces to access the content 22. This permits the messages 20 to be accessible to the largest possible audience 12, e.g., an audience member 12a, audience member 12b, audience member 12c, etc.

The message delivery system 10 may be unique, employing content 22 which is particular to only one message provider 14, and allowing them to differentiate themselves and their messages 20 from the traditional alternatives as well as from their competitors, such as the other message providers 32.

The message delivery system 10 may be targeted, due to the ability to identify and track the demographics of the audience 12, i.e., distinguishing audience member 12a, audience member 12b, audience member 12c, etc. from one another. To facilitate this a demographic database 40 may be used which includes an identification section 40a and an interests section 40b. This allows the message provider 14 to focus their communication resources in ways likely to yield a high return on investment.

The message delivery system 10 may be customizable, using subsets of content 22, e.g., a content 22a, content 22b, content 22c, etc. Such subsets of the content 22 may fit the subtleties in variety of interest within the audience 12 as a whole, or may be tailored for subsets of the audience 12, such as individual audience member 12a, audience member 12b, and audience member 12c distinct within the audience 12 as a whole. Such customization ability also permits easy modification and adaptation for different or specific uses.

The message delivery system 10 maybe inoffensive to the audience 12, providing intrinsic value to it which circumvents traditional ad avoidance behavior, and increases the effectiveness and efficiency with which the messages 20 are delivered.

The message delivery system 10 maybe interactive, taking advantage of the Internet's unique characteristics as an advertising medium to allow the message provider 14 to engage audience 12 on an interactive level, increasing the extent to which the messages 20 are internalized and producing more effective results than previous delivery systems.

The message delivery system 10 may be easily maintained and supported, permitting a close relationship between the message providers 14 and the content providers 16, and thus minimize costs and maximize productivity.

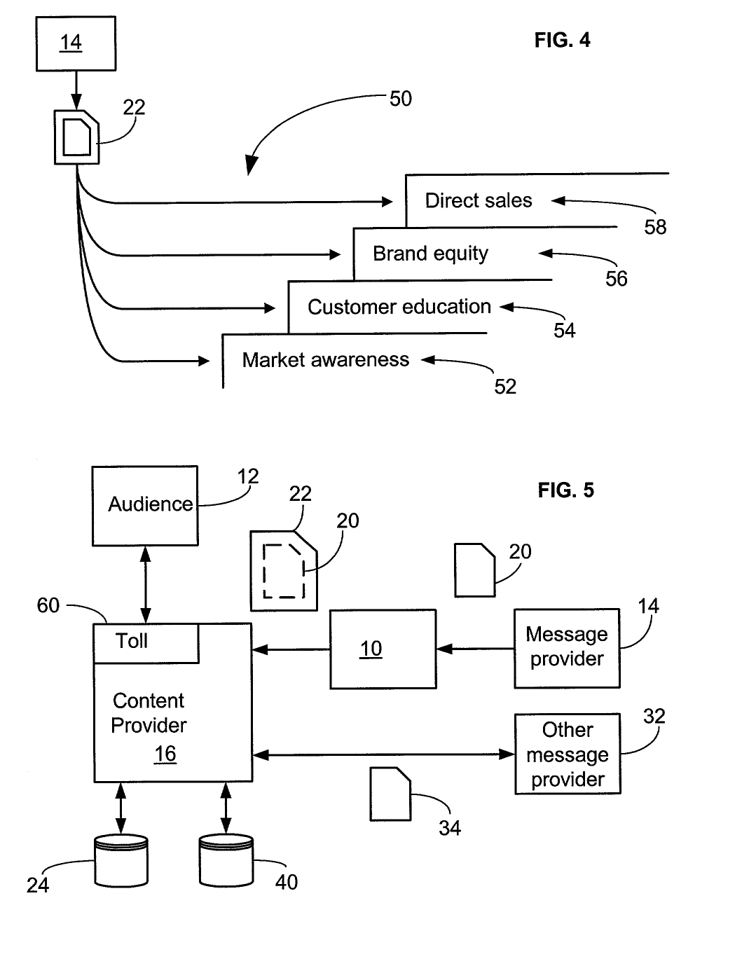

FIG. 4 is a schematic representation which stylistically depicts how the flexibility of the message delivery system 10 can extend to application in many different steps of a complete marketing plan 50. A message provider 14 can employ messages 20, embedded in content 22, in a market awareness stage 52, a customer education stage 54, a brand equity stage 56, and in a direct sales stage 58 of a campaign. No prior art message delivery systems have all, or even most, of these attributes or capabilities. Accordingly, the message providers 14 can be expected to readily adopt this new message delivery system 10.

FIG. 5 is a chart of information flow wherein an audience 12 seeks content 22 provided by a content provider 16. Here the audience 12 is shown topmost to emphasize its role as the origin or starting point in the process of its seeking out and retrieving the content 22. The process depicted in FIG. 5 is a pull based technique, rather than a push based one. Nothing happens unless the audience 12 is “pulled” to the content provider 16 and accesses the pre-stored content 22 in the content database 24.

FIG. 5 also serves to illustrate some motivations of the content providers 16 to pull the audience 12 to them. The possible models include a new message service model, an old message facilitating model, and a value providing model. These models are described separately, but it should particularly be appreciated that they may be used interchangeably and concurrently to a great degree.

In view of the discussion above, one obvious motivation for the content providers 16 is to supply message providers 14 with a new message service, one which they presumably will pay for. As described, a message provider 14 may provide a message 20 and the message delivery system 10 can embed that into the content 22 which the content provider 16 stores in its content database 24. The audience 12 then retrieves the content 22 and also the message 20. In FIG. 5 the message 20 embedded in the content 22 is shown in ghost form because this is only one option and the message 20 need not be present if this option is not used.

Another motivation of the content providers 16 is to pull the audience 12 to them to receive delivery of conventional messages. That is, the content providers 16 can act as the intermediaries 36, described above for FIG. 3, and also provide instances of the alternate messages 34. The content providers 16 can use the content 22 of the message delivery system 10 to entice the audience 12, say, to concurrently get it to view advertising. If abused, this may result in conventional ad avoidance behavior and, in turn, avoidance of such content providers 16 by the audience 12, but it is nonetheless a valid use of the message delivery system 10 and prudent usage can avoid problems.

Another, major, motivation for the content providers 16 to use the content 22 from the message delivery system 10 is to provide value to the audience 12 by supplying it with what it wants. If the audience 12 perceives that it is receiving something of value in the content 22, it will give value in return to obtain more of that content 22. A mechanism for the collection of such payment is generically depicted as a toll collector element 60 in FIG. 5.

The mode of payment may be quite varied. It may be by simply paying for access to the content 22, say, by buying membership in a website where it is available. Or the payment may be made in more subtle form. For example, the audience 12 may be asked questions for the sake of surveying, for pure information procurement or for later marketing. Referring briefly to FIG. 4 again, as part of a marketing plan 50 an audience 12 might be asked if it is aware of or interested in a new type of product or service. Alternately, the audience 12 may “pay” with information about itself which can be added to the demographic database 40, and then used or sold by the content provider 16. Describing methods in which value can be received from an audience 12 is not germane or even possible here. Instead, a key point to be appreciated here is that the attention of the audience 12 must be obtained and held for such methods to work and the present message delivery system 10 is very well suited for doing that.

Internet based content providers are constantly searching for “sticky” type content which they can provide to their audiences, but there is a shortage of it available. Sticky content is that which will not only attract a person but also keep him or her at the host's site for an extended period of time. Stickiness is one of the three most important factors that justify a high CPM (cost-per-thousand impressions, a standard metric used for buying and measuring media)(eAdvertising Report), and it follows that it is a key factor that drives the revenue of content providers 16.

Consistent with the goal of bringing the audience 12 to the message 20, the message delivery system 10 may create sticky content 22 that is: novel; intuitive; interactive; fast; thought-provoking; aesthetically pleasing; free, to the audience 12; and incentive oriented. When systems are interactive, free, and aesthetically pleasing they will have inherent value to their audiences and provide “sticky” users. The message delivery system 10 can provide such an audience 12 of sticky users at sites where the content 22 is available. When systems are intuitive, novel, aesthetically pleasing, and incentive oriented, large numbers of users will find using them to be easy, fun, and rewarding. The message delivery system 10 can also grow high user quantities in its audiences 12. When systems are free to their audiences, and are constantly refreshed and updated, and employ rewards and incentives, users will return to continue using them. The message delivery system 10 can provide a high degree of audience 12 usage, providing users who will spend extended periods of time. When systems are interactive they can be used to gather valuable demographic data on those who use them, particularly when coupled with rewards and incentives. The message delivery system 10 can particularly track the tastes and behaviors of its audiences 12. When systems are novel and innovative they can provide a means for companies to differentiate themselves from their competitors. And in this respect, in the minds of its audiences 12, the message delivery system 10 can provide such differentiation for its content providers 16. Systems can also foster a strong sense of community by allowing the users to interact with each other and by being thought provoking for them. The content of the message delivery system 10 can be made to encourage and facilitate communication between the members of its audience 12, and help to build such communities.

As has been repeated many times herein for emphasis, the key to bringing the audience 12 is the content 22. If the content 22 is not attractive enough, the audience 12 will not come. Three representative examples of the content 22 are now described with numerous variations. However, it should be appreciated it is not possible to describe all possible examples and variations herein, and that the true spirit and scope of the present invention extends beyond the necessarily limited number of pages of discussion and illustration provided herein.

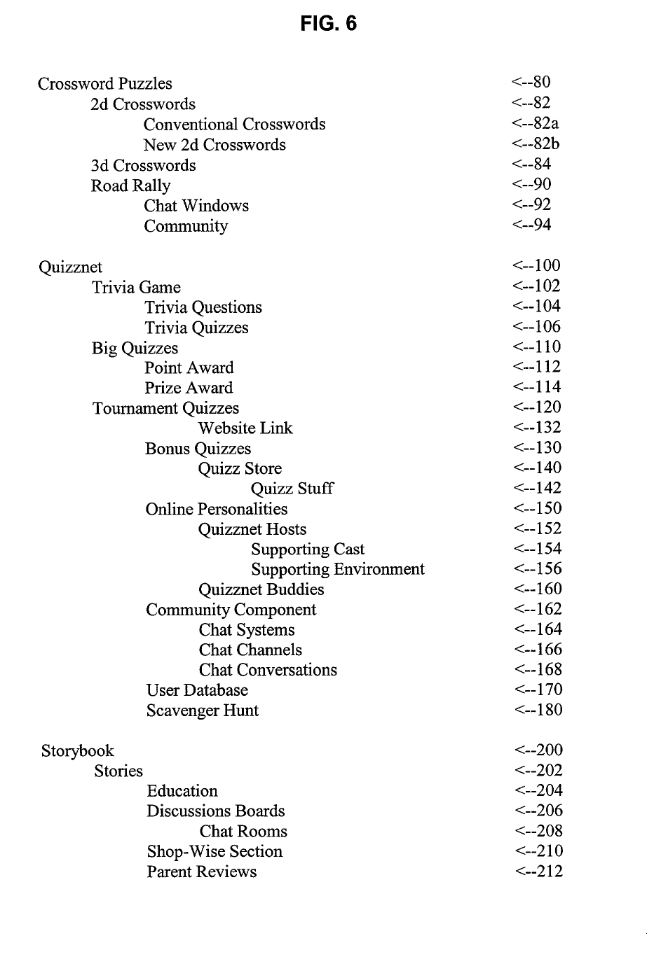

FIG. 6 is a table summarizing three examples of content 22 which are now described with variations. As a first example, the content 22 may be crossword puzzles 80, including both two-dimensional or 2D crosswords 82 and three-dimensional or 3D crosswords 84. Further, the 2D crosswords 82 may be conventional crosswords 82a or new 2D crosswords 82b. As described presently, true 3D crosswords 84 are new and are a separate invention in which the inventor has participated.

The demand today for conventional crossword puzzles by the public is extremely large and has not yet been adequately served online. In fact, crossword puzzles are one of the most popular forms of indoor entertainment, with over 40 million Americans solving at least one each week. However, fewer than ten unique new crosswords are available each day nationwide, in all media combined. Crossword puzzlers, as those enjoying them are sometimes called, tend to be educated and affluent, and between the ages of 35 and 60, i.e., the same people who constitute the majority of Internet users today.

This makes even conventional crossword puzzles, used as 2D crosswords 82, an appealing candidate for use as content 22 by the message delivery system 10. However, as noted, the ability to supply unique new crosswords has been quite limited and conventional sources simply cannot provide enough of them to feasibly serve as content 22 in the message delivery system 10.

Another problem is that the content 22 should be capable of carrying an embedded message 20. Conventional crossword puzzles do not presently do this, if for no other reason than that such would make crafting them even more burdensome. However, crossword puzzles can be created which do, i.e., the 2D crosswords 82 may be useable as content 22 and how this can be is discussed below with 3D crosswords 84.

Working with others, the present inventor has developed a new type of content 22 which is particularly suitable for use by the Internet-based message delivery system 10: three-dimensional crossword puzzles. Of particular present interest is that the systems used for this are able to create large numbers of both 2D crosswords 82 and 3D crosswords 84, and ones which are suitable for use as content 22 by the present message delivery system 10.

The development of three-dimensional crossword puzzles was previously thought to be logistically impossible but has now been accomplished, and the resulting 3D crosswords 84 are particularly suitable for online, Internet based audiences 12. It is impossible to present three-dimensional crosswords in traditional media, but 3D crosswords 84 may take advantage of emerging Internet technologies. Thus, 3D crosswords 84 are a novel puzzle type and are a candidate for use as content 22 to attract and hold the attention of a large Internet-based audience 12 of the message delivery system 10.

Large numbers of both 2D crosswords 82 and 3D crosswords 84 can now be produced, and as content 22 can target a large and unsatisfied Internet audience 12. The average 3D crossword puzzle takes approximately 30 minutes to complete, making then the type of scarce, sticky content that websites are actively seeking.

Now content providers 16 can create or receive unique puzzles weekly, biweekly, or monthly (as they prefer). These content providers 16 are then free to provide their audiences 12 with access to their puzzle type content 22, and employ any or all of the previously noted message service, message facilitating, or value providing models.

Under the message facilitating model, a content provider 16 may employ the stickiness of crossword puzzles 80 to run banner advertisements outside of the puzzle itself. One variation of this involves the role of the content provider 16 bifurcating into that of a content manufacturer, using the message delivery system 10 to produce the content 22, and that of a content host, who makes the content 22 available online. The content 22 may then have a standard, base price depending on the frequency of a subscription as well as a revenue-sharing agreement with the content host, in which the content manufacturer receives a portion of the revenue earned by advertisements placed around the crossword puzzles 80. In this way, the content manufacturer is able to “put its money where its mouth is” by pegging its own income to the success of the crossword puzzles 80 in generating revenue.

The 3D crosswords 84 also illustrate how a dual-revenue model that characterizes the message delivery system 10 may work. The message delivery system 10 can provide message 20 delivery service revenue as well as content 22 as product sales revenue.

In the message 20 delivery context, the 3D crosswords 84 represent an extremely powerful tool for online advertising. By inserting brand-specific terms such as corporate slogans, names of products or spokespersons, etc. into a 3D crosswords 84, a message provider 14 may deliver a message 20 of his or her choice. There are two particular ways for message providers 14 to advertise in 3D crosswords 84.

First, the message providers 14 may pay to insert a phrase into a 3D crosswords 84 that delivers an advertising message 20. A message provider 14 could purchase several clues, the answers to which would provide information on the product, policies, or any other facet of the business of the message provider 14. For example, if Nike wishes to advertise and use its connection to Michael Jordan, a clue could read “Jordan's shoe.” If Coca-Cola wants to reinforce its slogan, a clue could read “Always the Real Thing.” This type of advertising not only serves to simply reinforce the message 20 of the a message provider 14 through repetition, but also by encouraging the members of the audience 12 to “rack their brains” actively trying to connect the message 20 to the a message provider 14, and rewards them with a sense of satisfaction upon doing so. The 3D crosswords 84 thus provide a uniquely powerful advertising opportunity for message providers 14.

A second way that the 3D crosswords 84 can be used to advertise is for a message provider 14 to sponsor a particular 3D crossword 84, providing a prize such as a printable coupon, or a free product. This is an effective way of gaining new customers by creating a new demand for the product as well as a new market for supplementary products.

An addition which can be added to the crossword puzzles 80 is a road rally 90. In principle this can be applied to many forms of the content 22, but it will be described with reference here to the crossword puzzles 80, particularly the new 3D crosswords 84, which are expected to attract a large following due to their novelty.

The road rally 90 gives members of its audience 12 the opportunity to move from puzzle to puzzle via a list of the crossword puzzles 80 on a variety of pages, and offers a valuable prize to the first one to complete every puzzle. As the crossword puzzlers go from page to page competing against one another, they absorb messages 20 embedded in the content 22, which is the crossword puzzles 80. Additionally, the road rally 90 may offer a chat window 92, allowing the users to communicate with one another, to exchange comments and suggestions. Thus a community 94 will build which is loyal to the content provider 16, and as this community 94 grows, so will the number of hits on websites which advertise with the content provider 16. Instead of avoiding advertising, the audience 12 of users will seek it out, and, in doing so, seek out the pages that carry it. Also, sponsors of the crossword puzzles 80 can be mentioned in correspondence with the established community 94, thus utilizing permission advertising. The road rally 90 as an effective advertising tool can complement and support the crossword puzzles 80 themselves.

A different example of content 22 for the message delivery system 10 is quizznet 100. This is a sophisticated, interactive, online trivia game 102 featuring entertaining and interesting trivia questions 104 and constant playability. An audience 12 of World Wide Web users can logon to play for fun, prizes, and a competitive experience. The trivia questions 104 of the game can be targeted towards an audience 12 using a particular demographic slant. For example, a high school and college student may be reached by using an “anti-establishment” slant to encourage their participation.

As with content 22 of the message delivery system 10 generally, the messages 20 used may be embedded within the individual trivia questions 104, with sets of such questions, or even within an entire trivia game 102. Such trivia type content 22 can result in effective advertising, without drawing undesired or negative attention. By providing content 22 that is enjoyable for its audience 12 of web users, quizznet 100 allows its content providers 16 to deliver messages 20 for message providers 14 and others (e.g., alternate messages 34) without irritating its audience 12. This will particularly create value for websites because quizznet 100 is sticky, interactive, and entertaining, thereby helping attract a larger and longer staying audience 12 to these sites.

One possible addition to quizznet 100 is a big quiz 110. Each week a quizznet 100 type big quiz 110 can be released to the web public. Each such big quiz 110 might features 50 trivia questions 104 of which an average player will successfully answer 30 to 35. The trivia questions 104 used in the big quiz 110 can each be worth a point award 112, with the point value of a trivia questions 104 being determined by its difficulty. The audience 12 of players may choose to answer the trivia questions 104 immediately or to return later in the week. Each week, the top scoring player of that weeks' big quiz 110 may be given a prize award 114, perhaps one worth $100-$500. Other players may accumulate point awards 112 towards smaller incentives (see quiz stuff 142, below), limiting only one player to winning the big quiz 110 in a single time period.

One of the many possible variations of quizznet 100 and big quiz 110 is tournament quizzes 120. The players who earn sufficient point awards 112 in a big quiz 110 may become eligible for such tournament quizzes 120, held throughout the year. Those players who have won a big quiz 110 in the preceding time period become automatically eligible, as are the winners of preceding tournament quizzes 120.

Another variation is a bonus quiz 130. Every day, between one and ten such bonus quizzes 130 could be released to the public, for example. Such a bonus quiz 130 can be sponsored by a particular product manufacturer, and consist of 10 of the trivia questions 104. Five of these trivia questions 104 may regard the product, and five may be normal trivia questions 104. Optionally, a website link 132 can be made available to the product so that the audience 12 of players may research the trivia questions 104. No point awards 112 need be given for bonus quizzes 130, instead the first player to complete the bonus quiz 130 may receive the product as a form of prize award 114.

Another variation is a quiz store 140 stocking quiz stuff 142. The players of quizznet 100 may choose to transform point awards 112 which they earn through repeated play into quiz stuff 142 at the quiz store 140. The quiz stuff 142 may consists of small trinkets, knickknacks, and other items attractive to particular age groups and may, for instance, be emblazoned with the logos for quizznet 100, or of its hosts (see Interactive Features), etc. As the players gain more point awards 112, they are able to afford more impressive quiz stuff 142.

The ability to amass point awards 112 for better prizes and entry to tournament quizzes 120 is valuable for obtaining and maintaining a loyal audience 12. The quiz stuff 142 and the tournament quizzes 120 will thus help to maintain the user base which the big quizzes 110 will create.

A useful feature of which may be made core to the experience of quizznet 100 lies in the use of online personalities 150, which interact with the player as he or she proceeds through the trivia quizzes 106. These online personalities 150 take two forms, the first of which is a quizznet hosts 152.

Each quizznet host 152 may represents a different era of pop culture: hard-boiled detective novels, 1950's B-grade sci-fi, Neanderthal cavemen, monster movies, etc. The quizznet host 152 is the forum through which the game is introduced, the question presented, the prizes presented, and so forth. Each quizznet host 152 may be accompanied by a supporting cast 154 and supporting environment 156 which are compatible with the venue of the particular quizznet host 152, as well as the second form of the online personalities 150, the quizznet buddy 160. The quizznet buddy 160 accompanies the player through the game, but is the player's ally.

The quizznet hosts 152 and quizznet buddies 160 are capable of interacting with the trivia questions 104 themselves, the players' choices of answers, the game environment, and directly with the audience 12 of players. The quizznet hosts 152 can be made to respond to mouse clicks, be able to converse with the players (in a text box), and will prove to be an ample source of entertainment.

A strong community component 162 can make quizznet 100 successful. Such a community component 162 can center primarily around the use of chat systems 164, and variants like instant messaging, so that the audience 12 can be able to chat with each other about the trivia questions 104, trivia quizzes 106, etc. The players can choose whether or not to have chat systems 164 open as they play.

For the content providers 16 to make the community component 162 of their websites more entertaining, the quizznet hosts 152 can appear from time to time on certain chat channels 166. These online personalities 150 can interact with the players directly in the form of chat conversations 168.

Behind the front-end of quizznet 100 may be a user database 170 which is used to keep track of every user of quizznet 100, holding the user's points, current status, current game, preferences, and scores in each category and difficulty level. The audience 12 of users can log in anywhere, on any computer, and continue playing a game in quizznet 100 that they started elsewhere. With all information is stored centrally, the players are not limited to a single computer. This information is also valuable to the content providers 16 and the message providers 14, to know precisely where its user base is when and to further collect demographic information.

The delivery of content 22 embedded messages 20 is easily accomplished using quizznet 100. Thus, message providers 14 can pay to embed a question of their choice into a big quiz 110 or tournament quiz 120. By incorporating the messages 20 directly into a trivia question 104, quizznet 100 causes the audience 12 to learn the messages 20 in their attempts to answer that trivia question 104 correctly. For example, if Company X wants to increase its brand-awareness using quizznet 100, a question could appear which reads: “How long has Personality Y been the spokesperson for Company X?” This trivia question 104 stimulates interest in Company X in all of the audience 12 of quizznet 100. As the users try to answer the question, they will absorb Company X's message 20 without ever having felt “advertised at.”

Further advertising opportunity is deliverable through the use of bonus quizzes 130, which allow message providers 14 to promote their products or services directly, and the user database 170 can be used to facilitate such permission advertising. Thus, quizznet 100 offers the message market an entire range of message delivery opportunities.

Once sufficient quizznet hosts 152 and quizznet buddies 160 have been released to the public, a host scavenger hunt 180 may begin. In this game, the audience 12 of users (accompanied by their faithful quizznet buddy 160) search for the quizznet hosts 152 who have left the web site where the particular quizznet 100 is hosted.

The quizznet hosts 152 can be found on the web site of the contest sponsors, armed with their questions and surrounded by the sponsor's messages. Successfully answering the question of the quizznet host 152 earns the user points in the appropriate idiom. A certain number of points in each quizznet host 152 idiom can be necessary to successfully complete the scavenger hunt 180, and the first user to complete the scavenger hunt 180 wins a prize. The online personalities 150 of quizznet 100 may also provide links from site to site, accomplishing much the same end result as the road rally 90 does.

A third example of content 22 for the message delivery system 10 is storybook 200. The inventor's preferred version is dedicated to an audience of 3-5 year olds and their parents (the audience 12), but the concept is easily adaptable to other age groups and a variety of genre. At a website with storybook 200, children will be able to explore and interact with stories 202 suited to their preferences. The children, with the help of their parents, receive an education 204 in how to use a computer and play on the internet and may also learn how to read. Not only can storybook 200 make a site be an exciting place for kids to learn and interact with their parents, the parents can also use storybook 200 as a reference. They can access another part of the site with discussion boards 206 and chat rooms 208 for any questions which they may have about parenting. Such discussions boards 206 can be sponsored by companies wishing, as message providers 14, to get a message 20 out about their child and parent friendly products. Such message providers 14 may also choose to include coupons for their products in a shop-wise section 210, promoting new-brand awareness and customer retention. Additionally, parent reviews 212 of products and services can further benefit message providers 14 or companies acting as their own content providers 16, by generating communication with the consuming audience 12.

In storybook 200 the stories 202 (optionally with illustration) can be content 22, containing embedded messages 20. The messages 20 can range widely in variety. For example, public service type messages 20 about how to cross streets safely or to not play with dangerous household chemicals might be sponsored by national or state public safety organizations. Or messages 20 in the form of mentioning products or services targeted for either or both pf the child and adult audiences 12 can be interweaved into the stories 202.

As can be seen in the three general classes of examples used above, the content 22 can be chosen as almost anything desirable to the audience 12. It can be a challenge, based on chance, skill or intellect, one it can be an amusement, i.e., an entertainment like a story, play, video, or movie. Or it can be desirable for non-intrinsic reasons, such as a reward associated with obtaining or using content 22 which would otherwise not be desirable to the audience 12.

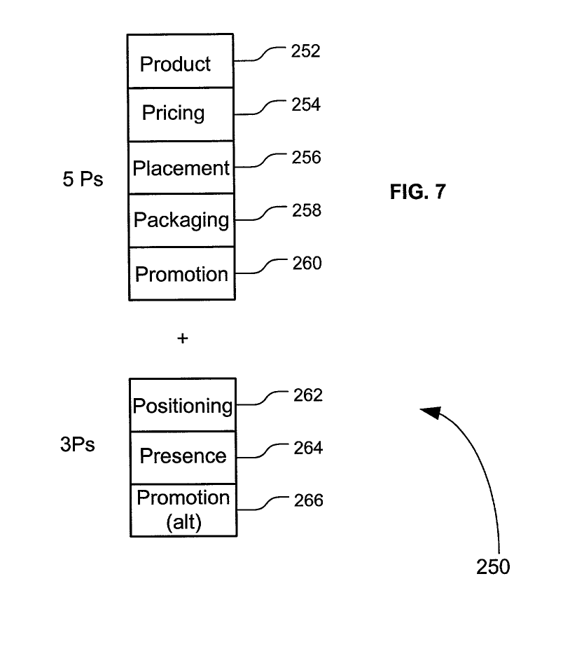

FIG. 7 is a block diagram depicting how the present message delivery system 10 can extend the traditional marketing model into a more powerful online marketing model 250. Most marketing strategies in the past decade have focused upon what are commonly referred to as the ‘Five P's of Marketing.’ The first “P” is product 252, what is being marketed (idea, service, or physical object). The second “P” is pricing 254, how much the target is charged for the product, in time or money. The third “P” is placement 256, the distribution system and levels upon which the product is sold. The fourth “P” is packaging 258, everything that comes with the product (service, rebates, warranties, etc.). And the fifth “P” is promotion 260, the advertising campaign to push targets at the product.

While focusing on these five points has proven to be effective in the past, this process breaks down with the advent of new media and product types, as can readily be see with the Internet already. The marketing of services and products on the Internet is different from selling cars in the traditional face-to-face manner, for example, and the current model begs to be adapted to the new online medium.

The present message delivery system 10 permits augmenting the traditional “5 P's” with 3 new P's. Specifically, a sixth “P” is positioning 262, determining the proper niche that the products and services will take in the market, and targeting a specific demographic that ensures appropriate revenue and recognition. A seventh “P” is presence 264, building a strong and well-connected presence on the Internet. And an eighth “P” is online promotion 266, which differs from traditional promotion 260 in an Internet strategy because the objective is to pull targets to the destinations and information rather than pushing them elsewhere to find it.

For each new content 22 designed and developed for the message delivery system 10, the marketing strategists can focus on all of these P's to create message delivery campaigns that will succeed on the Internet.

The use of positioning 262 involves defining a small but focused market niche and filling it by satisfying the needs of its member audience 12. Because Internet products and services often do not require a distribution infrastructure, marketing must be directed at highly specific targets to ensure that the niche audience 12 is aware of the product's existence.

The message delivery system 10 connects two niches in Internet communications. First, it provides content providers 16 with a means to attract audiences 12 that meet specific demographic requirements. Second, it provides message providers 14 with a communications system capable of transmitting messages to these same audiences 12. Leveraging each niche to complement the other—using the message delivery capability of content 22 to enhance the attractiveness of messages 20—which allows the message providers 14 and the content providers 16 to position themselves firmly within the Internet's message delivery framework.

The establishment of a strong Internet presence 264 is vital to marketing online. Branding on the Internet cannot be successfully accomplished without a strong presence, and as such the Internet presence 264 which the message delivery system 10 can provide can be key to an online marketing effort. Because the Internet is a pull medium, it is necessary to establish a presence that is strong and widespread enough to catch the attention of the potential audience 12. Without presence 264, promotion is impossible on the Internet.

Because advertising on the Internet consists of pull rather than push techniques, the art of online promotion 266 online bears little resemblance to traditional promotion 260. In order to draw clients, online promotion 266 must not only convey the message 20 but must do so in a fashion which causes the audience 12 to actively draw that message 20 to him- or herself. The use of online promotion 266 must be not only be well targeted but persistent; the audience 12 must be persuaded to return to the source of the information to learn more.

All of the ineffective established techniques ignore the fact that the Internet is a new medium, fundamentally different from its print and broadcast predecessors. Experience has shown that cross-media advertising techniques irritate audiences, making it difficult to communicate with them. This problem is compounded in the case of the Internet, which is the first medium to offer the potential for truly pull-advertising techniques, as opposed to traditional push methods. The established techniques are evolutionary, not revolutionary: they fail to recognize that the Web is a dynamic medium, where interactive technology reigns supreme. As such, they irritate users without effectively delivering a message.

The present message delivery system 10, however, is designed under a new paradigm that utilizes the Web's unique strengths, smoothly integrating messages 20 into the experiences of its audiences 12 in ways unavailable to traditional media. By presenting the messages 20 within content 22 rather than competing with it, the message delivery system 10 delivers the messages 20 in manners which the audiences 12 finds useful and enjoyable rather than bothersome. As such, the message delivery system 10 effectively delivers messages 20 while avoiding the pitfalls inherent in retrofitting outdated advertising methods to a new medium. By making advertising not only available, but also interesting to its audiences 12, the message delivery system 10 effectively stimulates those audiences 12 to learn the messages 20 of their own volition, enabling far more effective communication and advertising.

The end result of these efforts is an original message delivery system 10 that uses new media pull-advertising methods to engage audiences 12 on an active level, thereby circumventing ad avoidance behavior and the other drawbacks associated with traditional techniques.

A preferred embodiment of the present message delivery system 10 is practiced in the context of a personal computer such as an IBM (™) compatible personal computer, Apple Macintosh (™) computer, or UNIX based workstation. A representative hardware configuration of a workstation in accordance with the preferred embodiment comprises a central processing unit, such as a microprocessor, and a number of other units interconnected via a system bus. The workstation includes a Random Access Memory (RAM), Read Only Memory (ROM), an I/O adapter for connecting peripheral devices such as disk storage units to the bus, a user interface adapter for connecting a keyboard, a mouse, a speaker, a microphone, and/or other user interface devices such as a touch screen to the bus, communication adapter for connecting the workstation to a communication network (e.g., a data processing network), and a display adapter for connecting the bus to a display device. The workstation typically has resident thereon an operating system such as the Microsoft Windows NT (™) or Windows 95/98/ME (™) Operating System (OS), IBM's OS/2 (™), the MAC OS (™), or UNIX operating system.

Another embodiment of the present message delivery system 10 is practiced in the context of wireless communication devices. An audience may use a cellular phone, personal communication service (PCS), or a personal digital assistant (PDA) to access, perceive and interact with a content that embeds a message according to the present invention.

PDAs are hand-held devices that provide computing and information storage and retrieval capacities for personal and business use. PDAs such as Hewlett-Packard's Palmtop (™) and 3Com's PalmPilot (™) have evolved from handy device for storing schedule calendar and contact information into machines for crunching numbers, playing games or music, and downloading information from the Internet. PDAs fall into two major categories: hand-held computers and palm-sized computers. The major differences between the two are size, display and mode of data entry. Compared to palm-sized computers, hand-held computers tend to be larger and heavier. They have larger liquid crystal displays (LCD) and use a miniature keyboard, usually in combination with touch-screen technology for data entry. Palm-sized computers are smaller and lighter. They have smaller LCDs and rely on stylus/touch-screen technology and handwriting recognition programs for data entry. The present message delivery system can be practiced in both hand-held computers and palm-sized computers. The PDAs used for practicing the present message delivery system typically include a microprocessor such as Motorola Dragonball (™), Multiprocessor without Interlocked Pipeline Stages (MIPS, ™), or Hitachi's SH7709a, an operating system such as Palm OS (3Com, ™) or PocketPC (formerly called Windows CE, ™, Microsoft), a read-only memory (ROM) such as solid state memory, static RAM or Flash memory, batteries such as alkaline (AAA) batteries or rechargeable batteries (lithium, nickel-cadmium or nickel-metal hydride), a LCD display, input devices such as a miniature keyboard, a stylus, or a touch screen or a combination of keyboard, stylus and touch screen, and input/output ports for communication between PDA and PC for data synchronization, or between PDA and a wireless internet service provider.

Cellular phones use short-wave analog or digital transmission in which a subscriber has a wireless connection from a mobile telephone to a relatively nearby transmitter. Personal communications service (PCS) is a wireless phone service emphasizing personal service and extended mobility. Like cellular, PCS is for mobile users and requires a number of antennas to blanket an area of coverage. As a user moves around, the user's phone signal is picked up by the nearest antenna and then forwarded to a base station that connects to the wired network. The phone itself is slightly smaller than a cellular phone. The “personal” in PCS distinguishes this service from cellular by emphasizing that, unlike cellular, which was designed for car phone use with transmitters emphasizing coverage of highways and roads, PCS is designed for greater user mobility. It generally requires more cell transmitters for coverage, but has the advantage of fewer blind spots. Technically, cellular systems in the United States operate in the 824-849 megahertz (MHz) frequency bands; PCS operates in the 1850-1990 MHz bands. To this date, there are four different standards or technologies that are used in wireless phone technology. These are analog, Global System for Mobile (GSM), Time Division Multiple Access (TDMA), and Code Division Multiple Access (CDMA). Analog is used in cellular radio, and although it is the most available to the public, it is quickly giving way to its competitors. GSM is a digital technology, but has not become a leader amongst its competitors. TDMA is currently the most widely employed digital standard worldwide with some 36 million subscribers. It is a narrowband technology that digitizes the voice and compresses it so that up to eight conversations can be crammed into a single radio frequency. TDMA reduces each conversation into bursts assigned to particular slivers of time, then reassembles the pieces at the receiving end. CDMA is similar to TDMA, except even more conversations can be squeezed into a given slice of radio spectrum. It has been estimated that CDMA can transmit voice anywhere from ten to twenty times as densely as analog. TDMA can transmit voice about six to tenfold over analog. Companies such as Sprint PCS (™), PrimeCo (™), AT&T Wireless (™), and GTE Wireless (™) are all using CDMA standards. The present message delivery system can be practiced in a wireless phone context in which audience may access, perceive, and interact with the content embedded with a message.

In one embodiment, the message delivery system of the present invention can be utilized to deliver message to an individual user on a targeted basis. The message delivery system may identify the individual user, and select from a database a content based on a pre-determined customizable criterion relating to the individual user. In this way, the individual user may receive a content that is of greatest potential interest to him or her.

The pre-determined customizable criteria may include demographic information of an individual user. The demographic information can be identity type demographic data such as age, gender, date of birth, date of place, profession, and so on, and can also be interest type of demographic data such as sports, business, entertainment, travel, and so on.

The pre-determined customizable criteria may include a context on a web site or location on a web page where the content is presented. For example, the content presented on the sports section may be different from that on the business section of the NYTimes.com (™) web site. The content may also vary depending on whether it is appearing on the right side or bottom part of a web page. The content therefore can be selected to suit the context or location where the content is appeared to maximize impression and clickthrough.

An individual user that visits the content may be assigned a unique identifier. The message delivery system looks up the user in the database to determine his or her demographics. Then the system selects an appropriate content to suit the user's demographics. This method thus allows the message delivery system to target specific demographics more accurately than relying on a web site's general demographic profile justifying higher CPM's (the amount of money paid by companies for a thousand impressions). In addition, this method gives the individual user greater control over their content playing experience. It allows the user to select contents and to be served different level of the content each time the user goes to the content. Therefore, the message delivery system of the present invention can upgrade a content based on an identifier assigned to an individual user.

The message delivery system may also attach background information or a “skin” on a content that determines the appearance of the content background. The background information may contain a brand name of a sponsor sponsoring the content. This allows the message delivery system to bill the content sponsors and advertisers on a per impression basis. Each time a content is served it will create two impressions, one for the background and one for the content. This opens up tremendous possibilities for monetization of the message delivery system.

3DCrossServe, a message delivery system using 3DCrossword (™) puzzle game played on the Internet, is now described to further illustrate the present message delivery system for delivering message to an individual user on a targeted basis. There are two unique vehicles for brand message delivery available in 3DCrossword (™): the puzzle itself, with a title, a theme, and customized message embedded into the clues; and the skin, or sponsorship, of the puzzle that determines the appearance of the puzzle background and can contain brand images. By integrating advertising with game play, 3DCrossword (™) is not just entertaining content, it is an engaging advertisement.

3DCrossServe message delivery system selects a skin from a database of branded skins, and a puzzle from a database of sponsored puzzles, based on a pre-determined customizable criterion, such as the demographic information of an individual user, or a context or location where the puzzle is presented. 3DCrossServe message delivery system then puts the puzzle and skin together and serve the custom targeted puzzle to the user. At each time a 3DCrossword (™) is served it will create two impressions, one for the skin and one for the puzzle, thus opening up tremendous possibilities for monetization of the product.

When an individual user visits the 3DCrossword (™) page on a website, the user is presented with a choice of categories to play, such as sports, business, entertainment, etc. Upon selecting a category, for example, entertainment, the web site will call 3DcrossServe message delivery system with the type of puzzle the user wants, and assign a unique identifier for the user. 3DCrossServe then looks up the user in the database to determine their demographics. Suppose that the user is a 25 year-old male who regularly visits music related sites.

3DCrossServe then selects an appropriate puzzle and skin to suit the user's demographics and categorical selection, for example a skin sponsored by mp3.com and a puzzle sponsored by CDNow. This 3DCrossword (™) would then be sent back to the web site the user is viewing to be displayed.

3DCrossServe message delivery system is able to target specific demographics more accurately than relying on a web site's general demographic profile, thus justifying higher CPM's. More importantly, 3DCrossServe enable the sale of advertisement space in a more conventional manner, insuring a certain number of impressions to a specific demographic. In addition, 3DCrossServe can provide the users greater control over their puzzle playing experience. It allows them to select categories and to be served different puzzles each time they go to a site and even allows them to choose if they want 2D, 3D, or Enhanced puzzles.

By leveraging existing strengths of 3DCrossword (™), 3DCrossServe can deliver a form of advertising that is not only less intrusive, more entertaining and appropriate, but also highly effective in targeting individual users, and immune to the declining CPM phenomenon exhibited by other forms of online advertising. This immunity is due first to the fact that crosswords are not a fad (they have a dedicated, returning user base) and second to the fact that embedded advertisements are unobtrusive, so users do not find them irritating and therefore do not develop avoidance behavior towards them. This longevity makes 3DCrossword (™) and other engaging, embedded message delivery systems the first long-term solutions to the dilemma of online advertising.

The 3DCrossServe message delivery system is highly monetizable. This is due, foremost, to the fact that it fits conveniently into the existing online advertising infrastructure. This permits implementing an ad serving model where media buyers purchase a certain number of impressions to a specific demographic.

The revenue-potential of 3DCrossword (™) can be maximized under the 3DCrossServe message delivery system in several ways. First, by telling users that by registering they are able to receive upgrade puzzles, 3DCrossServe is able to collect the user information that helps the system to deliver the most targeted ads. Second, the value of individual puzzles can be maximized by simply changing a single puzzle slightly for each advertiser and then delivering the most appropriate version of the puzzle to the user.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

### INDUSTRIAL APPLICABILITY

The present message delivery system 10 is well suited for application in two major markets. The first market is message providers 14. This market includes advertising agencies, public relations firms, and education companies. The second market is content providers 16. This market includes online communities, entertainment websites, portal sites, and Web design firms.

In the “message market” today, potential message providers 14 are frustrated in their attempts to effectively deliver their messages to target audiences 12 on the Internet. This frustration has arisen from the failure of the available Internet-based message delivery systems such as banner ads, pop-up windows, “spam,” and site lists. These approaches are ineffective adaptations of push advertising techniques from print and television media to the inherently pull technology of the Internet.

These approaches are essentially passive techniques, requiring the audience to be exposed to them at least 27 times in order for the message to be successfully delivered. They do not create any value and, most importantly, have not been able to circumvent ad-avoidance behavior by the audience. Current estimates indicate that by 2002 the advertising component of the message market will be poised to spend close to a billion dollars on new alternatives to these techniques. This is a demand by message providers 14 which the message delivery system 10 is poised to serve.

The message market includes several sub-markets, one significant niche of which is composed of major advertising agencies. The “Big 8” advertising agencies (DDB Needham; TBWA Chiat/Day; BBDO; Goodby, Silverstein, & Partners; McCann-Erickson Worldgroup; Ogilvy & Mather Worldwide; Leo Burnett; and Young & Rubicam) handle the great majority of advertising in the United States. Several of these firms (DDB, McCann-Erickson, Ogilvy & Mather, and Leo Burnett, in particular) have already created a visible presence for themselves on the Internet via subsidiaries which are wholly devoted to Internet advertising. In 1999, $2.61 billion was spent on online advertising. Next year this figure is expected to double, and by 2002 it is forecast that $8.9 billion will be spent. Of these expenditures, 95% are made by the top 5% of online ad agencies. As such, these online advertising agencies represent a primary set of message providers 14 in the message market which will want the message delivery system 10.

A second subset of the message market includes major public relations (PR) firms and other companies who need to get a general message out to a specific group of people. The message delivery system 10 can also satisfy this need by offering message delivery on sponsor sites which targets the same demographic groups that these message providers 14 want to communicate with. Many of the major PR firms in this set of potential message providers 14 are subsidiaries of the Big 8 advertising agencies; namely the DAS (Diversified Agency Service) of Omnicom Group, Interpublic's Allied Communications Group, BSMG Worldwide of True North Communications, and Burston-Marsteller of Young & Rubicam. There are also large independent firms such as Edelman Worldwide and Ketchum Public Relations, as well as PR departments for most corporations that have budgets to get messages to the public. These are also potential message providers 14 of the message delivery system 10.

A third subset of the message market is online education companies. Included here are educational companies with supporting websites and companies that specialize in strictly on-line education, like Tutomet (™) and Cyberschool (™). Games and other activities have long been sought by teachers to educate their students in a fun way. Sites such as these are searching for engaging and fun educational tools to augment their content. Accordingly, these are also potential message providers 14 and audiences 12 of the message delivery system 10.

In summary, for all of the above examples, and many other potential message providers 14 as well, the present message delivery system 10 provides desirable methods to reach their audiences 12.

In the “content market” today, potential content providers 16 already operate thousands of websites which are engaged in intense competition to attract and retain a finite number of Web users. These sites measure success in terms of pageviews, visitors, and eyeballs. According to Forrester Research, in a 1999 report, high quality content is the most significant factor driving repeat visitors to their favorite websites. Such sites seek novel, entertaining, value-added content that will encourage visitors to spend more time there. Such content is known in the industry as “sticky.” The present message delivery system 10 is poised to satisfy this market, because its various embodiments may be inoffensive and possess intrinsic value to the audience 12. This will attract content providers 16 to purchase content made with the message delivery system 10.

The content market is also composed of several sub-markets, or niches. A large niche in the content market is that of Web entertainment or information sites. These consist of news sites (e.g., CNN, MSNBC, NYTimes, etc.), sports sites (e.g., ESPN, Sportsline, CNN-SI, etc.), game sites (e.g., Bezerk, GameDepot, Uproar, etc.), and others. These popular sites depend upon their content to draw a returning user base. As such, in order to keep users at their site, and to have them return, these sites are constantly looking for novel and entertaining new content. The message delivery system 10 can provide such content providers 16 with interactive and unique content for their audiences 12.

A second niche in the content market consists of the sites known as Web communities. These sites include Geocities, Xoom, Tripod, Angelfire, MSN, iVillage, About, and others. Community sites, like entertainment and information sites, are also seeking engaging content for their users. The key to these sites is not only interactive content, but also interaction between the users themselves. With the content which the message delivery system 10 can provide, audiences 12 can spend time with one another while enjoying the content.

A third niche of the content market that the message delivery system 10 can serve in the near future consists of those sites known as “Web portals.” These sites include Yahoo!, MSN, AOL, Go, Excite, AltaVista, and more. These are sites which “don't want visitors to immediately link to another site, they want them to stick around awhile” (eAdvertising Report). Web portals are searching for the same sticky content needed by the information and entertainment sites. These portals, however, must be kept abreast of what is available on the Web, so that they can provide their users with similar content within their own site. The message delivery system 10 can provide content which gives portal type content providers 16 the stickiness they need right on their own sites to attract and retain their target audiences 12.

In summary, for the above example content providers 16 and for many potential others as well, the present message delivery system 10 provides desirable content for their audiences 12.

For these reasons, and others, it is expected that the delivery system 10 of the present invention will have widespread industrial applicability and it is therefore expected that the commercial utility of the present invention will be extensive and long lasting.

What is claimed is:

1. A method for delivering messages to an individual audience member on an interactive communications network, the method comprising the steps of:
(a) providing a message intended for the individual audience member;
(b) selecting a content from a database based on a pre-determined customizable criterion relating to the individual audience member;
(c) embedding said message in said content such that said message becomes an embedded message; and
(d) permitting the individual audience member to access said content such that said embedded message is perceived when perceiving said content.

2. The method of claim 1, wherein said pre-determined customizable criteria include demographic information of the individual audience member.

3. The method of claim 2, wherein said demographic information includes at least one member of the set consisting of identity type demographic data and interest type demographic data.

4. The method of claim 1, wherein said pre-determined customizable criteria include a context on a web site or location on a web page where said content is appeared.

5. The method of claim 1, before step (c) further comprising a step of attaching background information onto said content.

6. The method of claim 5, wherein said background information includes information about a sponsor sponsoring said content.

7. The method of claim 6, wherein said background information includes a brand image of said sponsor.

8. The method of claim 1, wherein said step (c) includes assigning a unique identifier to the individual audience member for accessing said content.

9. The method of claim 8, further comprising a step of upgrading said content based on the identifier of the individual audience member.

10. The method of claim 1, wherein said embedded message includes an advertisement to vie for attention of the audience member in a competitive context.

11. The method of claim 10, wherein said advertisement includes a member of the set consisting of trademarks, service marks, product names, service names, candidate names, slogans, jingles, logos, comparative statistics, and comparative endorsements.

12. The method of claim 1, wherein said embedded message includes a communication, to attract attention of the audience member in an educational context.

13. The method of claim 1, wherein said content has a visually perceptible component and said embedded message is formatted as at least one member of the set consisting of text, images, and logos, and is included into said visually perceptible component.

14. The method of claim 1, wherein said content has an audibly perceptible component and said message is formatted as at least one member of the set consisting of speech, recorded audio, and generated sounds, and is included into said audibly perceptible component.

15. The method of claim 1, wherein said content is desirable to the audience member as an amusement.

16. The method of claim 1, wherein said content is desirable to the audience member as a challenge.

17. The method of claim 16, wherein said challenge includes a member of the set consisting of games, puzzles, and contests.

18. The method of claim 17, wherein said embedded message is formatted as a member of the set consisting of answers and clues regarding said challenge.

19. The method of claim 1, wherein said content is desirable to the audience member because accessing said content is rewarding to the audience member.

20. The method of claim 1, wherein said content is themed, to entice the audience member to seek out and retrieve said content from a limited set of content providers.

21. The method of claim 1, wherein said content is unique, to entice the audience member to seek out and retrieve said content from an exclusive content provider.

22. The method of claim 1, wherein:
said message is provided by a message provider; and
said content is provided by a content provider which is distinct from said message provider and which embeds said message into said content and makes said content accessible to the individual audience member as a commercial service.

23. The method of claim 1, wherein said content is provided to the audience member in exchange for a member of the set consisting of free, monetary values, non-monetary values.

24. The method of claim 17, wherein said non-monetary value includes the audience member answering at least one question.

25. A system for delivering messages to an individual audience member on an interactive communications network, comprising:
(a) logic that provides a message intended for the individual audience member;
(b) logic that selects a content from a database based on a pre-determined customizable criterion relating to the individual audience member;
(c) logic that embeds said message in said content such that said message becomes an embedded message; and
(d) logic that permits the individual audience member to access said content such that said embedded message is perceived when perceiving said content.

26. The system of claim 25, wherein said pre-determined customizable criteria include demographic information of the individual audience member.

27. The system of claim 26, wherein said demographic information includes at least one member of the set consisting of identity type demographic data and interest type demographic data.

28. The system of claim 25, wherein said pre-determined customizable criteria include a context on a web site or location on a web page where said content is appeared.

29. The system of claim 25, further comprising logic that attaches background information onto said content.

30. The system of claim 29, wherein said background information includes information about a sponsor sponsoring said content.

31. The system of claim 30, wherein said background information includes a brand image of said sponsor.

32. The system of claim 25, wherein said logic (c) includes logic that assigns a unique identifier to the individual audience member for accessing said content.

33. The system of claim 32, further comprising logic that upgrade said content based on the identifier of the individual audience member.

34. The system of claim 25, wherein said embedded message includes an advertisement to vie for attention of the audience member in a competitive context.

35. The system of claim 34, wherein said advertisement includes a member of the set consisting of trademarks, service marks, product names, service names, candidate names, slogans, jingles, logos, comparative statistics, and comparative endorsements.

36. The system of claim 25, wherein said embedded message includes a communication, to attract attention of the audience member in an educational context.

37. The system of claim 25, wherein said content has a visually perceptible component and said embedded message is formatted as at least one member of the set consisting of text, images, and logos, and is included into said visually perceptible component.

38. The system of claim 25, wherein said content has an audibly perceptible component and said message is formatted as at least one member of the set consisting of speech, recorded audio, and generated sounds, and is included into said audibly perceptible component.

39. The system of claim 25, wherein said content is desirable to the audience member as an amusement.

40. The system of claim 25, wherein said content is desirable to the audience member as a challenge.

41. The system of claim 40, wherein said challenge includes a member of the set consisting of games, puzzles, and contests.

42. The system of claim 41, wherein said embedded message is formatted as a member of the set consisting of answers and clues regarding said challenge.

43. The system of claim 25, wherein said content is desirable to the audience member because accessing said content is rewarding to the audience member.

44. The system of claim 25, wherein said content is themed, to entice the audience member to seek out and retrieve said content from a limited set of content providers.

45. The system of claim 25, wherein said content is unique, to entice the audience member to seek out and retrieve said content from an exclusive content provider.

46. The system of claim 25, wherein:
said message is provided by a message provider; and
said content is provided by a content provider which is distinct from said message provider and which embeds said message into said content and makes said content accessible to the individual audience member as a commercial service.

47. The system of claim 25, wherein said content is provided to the audience member in exchange for a member of the set consisting of free, monetary values, non-monetary values.

48. The system of claim 47, wherein said non-monetary value includes the audience member answering at least one question.
